(19) United States
(12) Patent Application Publication
(10) Pub. No.: US 2005/0191107 A1
(43) Pub. Date: Sep. 1, 2005

(54) Tape cartridge with speed restricting mechanism

(76) Inventor: Martin Stuart Christie, Potterspury (GB)

Correspondence Address: KNOBBE MARTENS OLSON & BEAR LLP, 2040 MAIN STREET, FOURTEENTH FLOOR, IRVINE, CA, 92614, US

(21) Appl. No.: 11/068,405

(22) Filed: Feb. 28, 2005

(30) Foreign Application Priority Data
Mar. 1, 2004 (GB) GB 0404527.4

(51) Int. Cl. B41J 35/28

(52) U.S. Cl. 400/208

(57) ABSTRACT

A tape cartridge for a personnel barrier system includes a spool (14) of tape (16), a housing (6), a return spring (26) and a speed restricting mechanism. The speed restricting mechanism includes a rotor device (38) that is connected to the spool (14) for rotation therewith in at least one rotational direction, the rotor device being immersed in a viscous damping medium (40).

### RELATED APPLICATIONS

This application claims priority to GB 0404527.4, filed Mar. 1, 2004 which is incorporated herein by reference.

### BACKGROUND OF THE INVENTION

1. Field of the Invention

The present invention relates to a tape cartridge with a speed restricting mechanism, and in particular but not exclusively to a tape cartridge that forms part of a personnel barrier system.

2. Description of the Related Art

Personnel barrier systems that use retractable tapes are well known. Typically, a flat woven tape is wound onto a spool in a cartridge. The spool is spring-biased for example using a clock spring to rewind the tape into the cartridge after use.

Sometimes, a speed restricting mechanism is provided, to prevent the tape from rewinding too quickly. If the tape is retracted too quickly, the end of the tape can whip violently, possibly causing injury to bystanders or damage to property.

One such speed restricting system is described in U.S. Pat. No. 5,967,443. This system uses a centrifugal braking system in which a pair of brake blocks that rotate with the spool are urged outwards by centrifugal forces against a stationary brake drum when the spool rotates. A disadvantage of this arrangement is that the mechanism is relatively expensive to produce and it suffers from excessive brake-wear, making use of the system less convenient. It is also susceptible to ingress of dust, moisture and wear debris, which can significantly affect braking performance. Furthermore, the system only comes into operation when the spool reaches a certain speed.

It is an object of the present invention to provide a speed restricting mechanism that mitigates at least some of the aforementioned disadvantages.

### SUMMARY OF THE INVENTION

According to the present invention there is provided a tape cartridge for a personnel barrier system, said tape cartridge including a spool of tape, a housing, a return spring and a speed restricting mechanism, said speed restricting mechanism including a rotor device that is connected to said spool for rotation therewith in at least one rotational direction, said rotor device being immersed in a viscous damping medium.

The mechanism is capable of restricting the speed at which the tape is rewound into the cartridge, thereby reducing or eliminating the risk of injury to bystanders and reducing wear on the tape and the cartridge. The mechanism is very simple and inexpensive, requiring only a few simple components. It is also very small and does not significantly increase the overall size of the tape cartridge. The speed restricting system also operates immediately the tape is retracted (i.e. without any delay), thereby preventing the occurrence of excessive retraction speeds.

Advantageously, the rotor device is connected directly to the spool. This provides a very simple but effective and reliable mechanism.

Alternatively, the rotor device may be connected to the spool via a one-way drive mechanism, for example a clutch or ratchet mechanism. This allows the speed restricting mechanism to operate when the tape is being retracted into the cartridge. However, when the tape is being drawn from the cartridge, the speed restricting mechanism does not operate, thus making use of the system more convenient.

Advantageously, the rotor device is connected to the upper end of the spool, this location being preferred for manufacturing and maintenance reasons.

The viscous damping medium is preferably contained within a chamber provided within the upper part of the housing. The chamber is preferably sealed, so that it is invulnerable to contamination and humidity. The chamber may be formed between an upper support member and an end cap of the housing.

The viscous damping medium is preferably a liquid or grease.

### BRIEF DESCRIPTION OF THE DRAWINGS

Certain embodiments of the present invention will now be described, by way of example, with reference to the accompanying drawings, in which:

FIG. 1 is a sectional side elevation of a tape cartridge that includes a speed restricting mechanism;

FIG. 2 is a cross-section on line II-II of FIG. 1;

FIG. 3 is a top plan view of the tape cartridge of FIG. 1 with an end cap removed;

FIG. 4 is an isometric view of a rotor forming part of the speed restricting mechanism, and

FIG. 5 is a top plan view of an alternative tape cartridge with an end cap removed.

### DETAILED DESCRIPTION OF THE PREFERRED EMBODIMENT

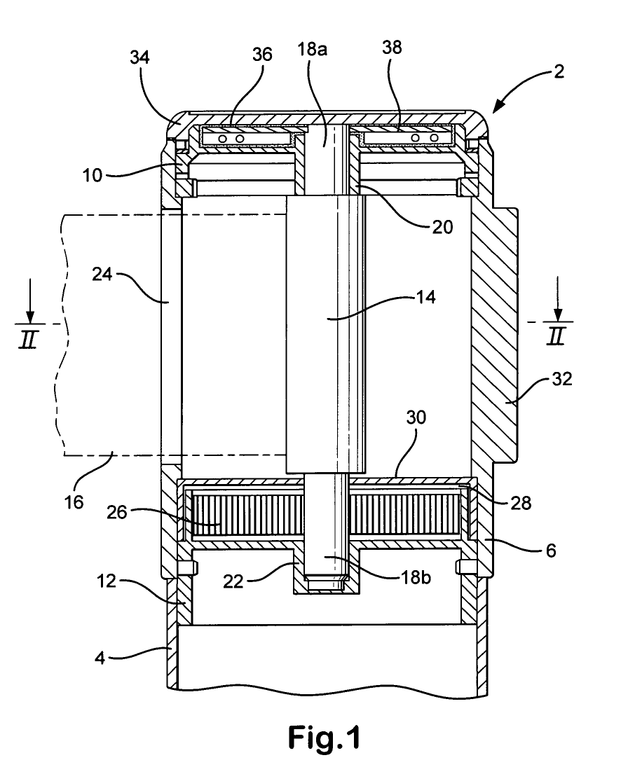

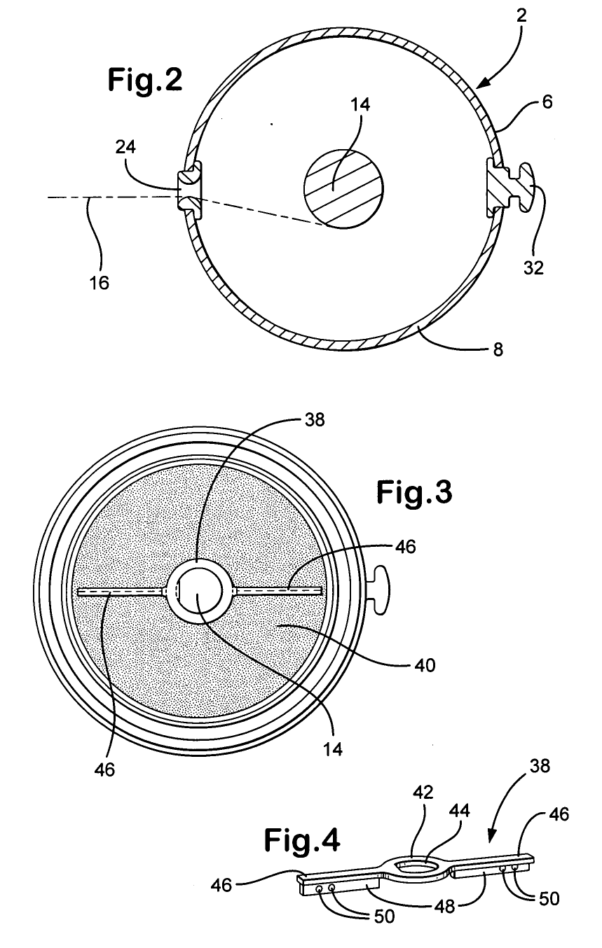

A tape cartridge 2 for a personnel barrier system is shown in FIGS. 1 to 3. The cartridge 2 is typically mounted on top of a barrier post 4 having a weighted base (not shown). Alternatively, the cartridge may for example be attached to a wall. The barrier system can be used to create a temporary barrier, for example to guide a queue of people.

The tape cartridge 2 includes a substantially cylindrical housing 6, having a steel cylindrical wall 8 and upper and lower support members 10, 12, formed as plastics mouldings. A rotary spool 14 of woven tape 16 is mounted in the housing. The spool has a central shaft 18, the upper and lower ends 18a, 18b of which are mounted in rotary bearings 20, 22 in the upper and lower support members. Tape can be withdrawn through a slot 24 in the housing, causing the spool 14 to rotate. A clock spring 26 is located in a chamber 28 provided in the lower support member 12, which is closed by a cover plate 30. The clock spring 26 is connected to the lower end 18b of spool shaft 18. The clock spring 26 is wound up when the tape is withdrawn from the cartridge and retracts the tape back into the cartridge when the tape is released. The cartridge also includes a connector 32 to which the end of another tape may be connected to create a barrier. The cartridge 2 is sealed closed at its upper end by means of an end cap 34.

The tape cartridge includes a speed restricting mechanism, which serves to restrict the speed at which the tape is retracted into the cartridge when the tape is released, to reduce or eliminate the risk of injury to bystanders.

The speed restricting mechanism includes a shallow cylindrical chamber 36, formed between the upper support member 10 and the end cap 34, and a rotor device 38. The chamber is filled with a high viscosity substance 40, for example silicon grease or any suitable alternative. The upper end of the chamber 36 is sealed closed by the end cap 34.

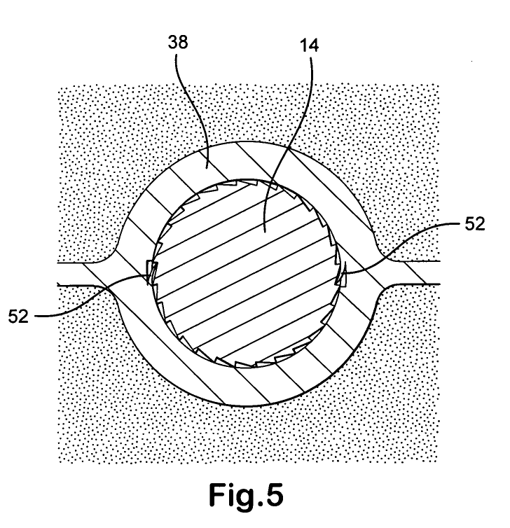

The rotor device 38, which is shown in more detail in FIGS. 3 and 4, includes a central ring 42 having a D-shaped bore 44 that fits over a similarly-shaped portion of the spool shaft 18 at the upper end of the spool 14. The rotor device 38 therefore rotates with the spool 14 whenever tape is withdrawn from or retracted into the cartridge 2. A pair of arms 46 extend radially outwards from the central ring 42. Each of these arms 46 carries a vane 48 having a plurality of through holes 50. The vane is of a size and shape to substantially fit the grease-filled chamber, with only a small clearance around the sides of the vane.

In use, the rotor 38 rotates with the spool 14 as tape is withdrawn from or retracted into the cartridge. Rapid rotation of the spool in either direction is restricted by the fact that the rotor has to move through the highly viscous grease 40 that fills the chamber 36. This causes drag, which provides a braking effect that is proportional to the speed of rotation. The amount of braking can if necessary be adjusted by changing the size and shape of the vanes 48, the number and size of the through holes and the viscosity of the grease. The rotor can also be provided with more or fewer arms and vanes, if necessary.

When tape is withdrawn or retracted, the spool 14 rotates and the rotor 38 rotates with it. If the tape is withdrawn and then released, it is retracted into the cartridge by the spring 26. The speed at which the tape is retracted is limited by the braking action of the speed restricting mechanism. For example, we have found that for a typical cartridge with a fully withdrawn tape, the retraction time is increased from less than one second to approximately 2-3 seconds.

The braking mechanism may be modified as shown in FIG. 5 to include a one-way drive mechanism 52 (for example a clutch or ratchet mechanism) between the spool 14 and the rotor 38, which allows relative rotation between the spool and the rotor in one rotational direction and prevents relative rotation in the opposite direction. With this arrangement, the braking mechanism can be designed to operate so that a braking effect is provided only when the spool is rotating in one direction, for example when the tape is being retracted into the cartridge, while allowing free, uninhibited rotation of the spool in the other direction, when tape is being withdrawn from the cartridge.

Various other modifications of the above described invention are of course possible, for example with regard to the shapes, dimensions and materials of the component parts. In addition, the rotor may be connected to the spool via a transmission system, for example, a set of gears, to increase or decrease the rotational speed of the rotor relative to the spool, thus affecting the braking effect.

1. A tape cartridge for a personnel barrier system, said tape cartridge comprising a spool of tape, a housing, a return spring and a speed restricting mechanism, said speed restricting mechanism comprising a rotor device that is connected to said spool for rotation therewith in at least one rotational direction, said rotor device being immersed in a viscous damping medium.

2. A tape cartridge according to claim 1, wherein the rotor device is connected directly to the spool.

3. A tape cartridge according to claim 1, wherein the rotor device is connected to the spool via a one-way drive mechanism.

4. A tape cartridge according to claim 1, wherein the rotor device is connected to the upper end of the spool.

5. A tape cartridge according to claim 1, wherein the viscous damping medium is contained within a chamber provided within the upper part of the housing.

6. A tape cartridge according to claim 5, wherein the chamber is sealed.

7. A tape cartridge according to claim 5, wherein the chamber is formed between an upper support member and an end cap of the housing.

8. A tape cartridge according to claim 1, wherein the viscous damping medium is a liquid or grease.
